(19) United States
(12) Patent Application Publication
(10) Pub. No.: US 2021/0058376 A1
(43) Pub. Date: Feb. 25, 2021

(54) ANONYMIZATION AND RANDOMIZATION OF DEVICE IDENTITIES

(71) Applicant: Noodle Technology Inc., San Francisco, CA (US)

(72) Inventors: Eliott Quentin Eric Teissonniere, San Francisco, CA (US); Lucien Jean Baptiste Loiseau, San Francisco, CA (US); Micha Anthenor Benoliel, San Francisco, CA (US); Garrett Edward Kinsman, San Francisco, CA (US)

(21) Appl. No.: 17/000,338

(22) Filed: Aug. 23, 2020

Related U.S. Application Data
(60) Provisional application No. 62/891,116, filed on Aug. 23, 2019.

(51) Int. Cl. H04L 29/06; H04L 9/06; H04L 9/08

(52) U.S. Cl. CPC H04L 63/0421; H04L 9/085; H04L 9/0643

(57) ABSTRACT

A method may include generating a unique identifier for an endpoint device. The unique identifier may be specific to the endpoint device and may be configured to identify the endpoint device with at least one semi-trusted party. The unique identifier may be a hashed value based on both the endpoint device's MAC address and an operator secret known to a network operator. The method may include sharing the unique identifier with another device.

### BACKGROUND

The present disclosure generally relates to security and privacy for communication between networked “smart” devices. In particular, the present disclosure describes secure and private identification for networked devices.

The Internet of things (IoT) is the concept of connecting ordinary devices like lights and doors to a computer network to make them “intelligent.” An embedded system or a computer connects each device together in a network and to the internet. The connections allow each device to collect and exchange data, and permits them to be controlled remotely or permits them to remain updated, or be controlled remotely or by setting rules or chains of actions.

The use of IoT devices is expanding into many aspects of human life, and experts estimate that the IoT will have almost 50 billion devices by 2020. Increasingly, IoT devices are being used for healthcare at hospitals, and in medical device and pharmaceutical manufacturing. In cities, IoT devices help track and monitor pollution. IoT devices can also be used by governments, militaries, companies, and individuals for asset tracking and management. Although these applications serve different purposes, many of them require strong security and privacy controls.

Security and privacy concerns have long plagued the Internet. Increased mobile device usage has increased these security and privacy concerns, and the advent IoT devices has heightened security and privacy concerns even further. Accordingly, the present disclosure relates to secure and private identification for networked devices.

The claimed subject matter is not limited to embodiments that solve any disadvantages or that operate only in environments such as those described above. This background is only provided to illustrate examples of where the present disclosure may be utilized.

### SUMMARY

The present disclosure generally relates to security and privacy for communication between networked “smart” devices. In particular, the present disclosure describes secure and private identification for networked devices.

In one non-limiting example, a method may include generating a unique identifier for an endpoint device. The unique identifier may be specific to the endpoint device and may be configured to identify the endpoint device with at least one semi-trusted party. The unique identifier may be a hashed value based on both the endpoint device's MAC address and an operator secret known to a network operator. The method may include sharing the unique identifier with another device.

In some aspects, the MAC address may be defined by hardware of the endpoint device. The unique identifier may be shared wirelessly. The unique identifier may be shared via a network operated by a network operator.

The unique identifier may be generated according to algorithm id=hash(operatorSecret, deviceMacAddress), wherein id is the unique identifier, hash is a hashing algorithm, operatorSecret is a secret known by a network operator, and deviceMacAddress is a MAC Address define by hardware of the endpoint device. The hashing algorithm may be a Secure Hash Algorithm (SHA).

The unique identifier may not be understandable by third parties and may be linkable to the endpoint device by a network operator. The unique identifier may be generated at the endpoint device. The method may include recomputing the unique identifier at a network operator. Sharing the unique identifier with another device may include transmitting the unique identifier to another device owned by a network operator.

The method may include rotating the operator secret. The operator secret may be rotated based on a rotation algorithm known to a network operator. The rotation algorithm may include predefined parameters known to the network operator.

In another example, a method may include rotating an operator secret known to a network operator, generating a unique identifier for an endpoint device, and sharing the unique identifier with another device. The unique identifier may be specific to the endpoint device and may be configured to identify the endpoint device. The unique identifier may be based on the operator secret and an identifier of the endpoint device.

The identifier of the endpoint device may be a MAC address. The MAC address may be defined by hardware of the endpoint device. The operator secret may be known to the network operator. The unique identifier may be shared wirelessly via a network operated by the network operator.

The unique identifier may be generated according to algorithm id=hash(operatorSecret, deviceMacAddress), wherein id is the unique identifier, hash is a hashing algorithm, operatorSecret is the secret known by the network operator, and deviceMacAddress is a MAC Address define by hardware of the endpoint device. The hashing algorithm may be a Secure Hash Algorithm (SHA).

This Summary introduces a selection of concepts in a simplified form that are further described below in the Detailed Description. This Summary is not intended to identify key features or essential characteristics of the claimed subject matter, nor is it intended to be used as an aid in determining the scope of the claimed subject matter.

### BRIEF DESCRIPTION OF THE DRAWINGS

FIG. 1 illustrates an example network architecture.

FIGS. 2-3 illustrate flow diagrams of example methods to securely and privately identify networked devices.

FIG. 4 illustrates a diagrammatic representation of a machine in the example form of a computing device within which a set of instructions, for causing the machine to perform any one or more of the methods discussed herein, may be executed.

### DETAILED DESCRIPTION

Reference will be made to the drawings and specific language will be used to describe various aspects of the disclosure. Using the drawings and description in this manner should not be construed as limiting its scope. Additional aspects may be apparent in light of the disclosure, including the claims, or may be learned by practice.

As the number of Internet of Things (IoT) devices increases, security and privacy concerns associated with these devices also increases, especially as IoT devices expand more and more, for example, in commercial and industrial applications.

IoT devices may periodically emit signals that include identifying information about the device and its purpose. In some circumstances, it may be possible to correlate individuals with their devices based on these beacons. This includes not only phones and tablets, but also auxiliary devices such as asset trackers, health monitoring devices, car keys, wireless watches, etc.

However, by collecting identifying information from IoT devices, a wrongdoer may be able to infer or deduce which individuals own which devices, as well as the physical location of individuals, simply by tracking with which devices they spend significant time in close proximity. Once a wrongdoer has determined who owns which devices, that information may be used to impersonate the device and track the device and its owner. Some IoT devices may use global positioning system (GPS) to locate assets a user wants to track, such as a set of keys. The assets may transmit beacons that may be sent or relayed to device manufacturers. Unfortunately, a wrongdoer may use this information to identify the location of devices and associated users or assets.

IoT devices and the signals they emit may also lead to privacy concerns. For example, IoT devices may emit signals that includes a unique, unchanging, device ID. This enables device tracking, but also exposes a vulnerability, because nearby devices may see the unique ID and may use this information to identify and track the device without permission.

Operators of IoT device networks may classify IoT devices in two categories: 1) devices that do not need to be uniquely identified and 2) devices that need to be identified. For devices that need to be identified, a common way to identify such devices is to use its MAC Address, which may be defined by a device's hardware (most commonly in the Bluetooth chipset). However, using the MAC address for identification may be associated with several significant disadvantages.

First, identifying a device by its MAC Address means that this same address cannot be randomized in order to avoid the device from being tracked, this may result in security and privacy concerns. For example, a device's owner may be tracked simply by checking where the IoT device is located (e.g., via GPS or network connection location). This may be a significant concern for wearable devices such as watches, which are intended to be worn by its owner at all times, and may allow its owner to be tracked at all times. Second, the MAC Address of a device may be easily spoofed by another device with the right hardware and software. Currently, such hardware and software are easily available for purchase, for example, on the internet.

Accordingly, MAC Addresses are not a good way to identify IoT devices: they are not secure because they are easy to spoof, and a privacy concern because they make any device easy to track. Thus, the present disclosure describes systems and methods to identify IoT devices in a secure and private manner. In particular, the present disclosure includes device identifiers that are difficult to spoof and appear random to third parties while linkable to the network's IoT devices for the network's operator only. Additionally, the disclosed identifiers are easy to implement and fast to compute (without requiring too many operations), which makes them suitable to implement in IoT devices that rely on small batteries and relatively low performance and low power hardware.

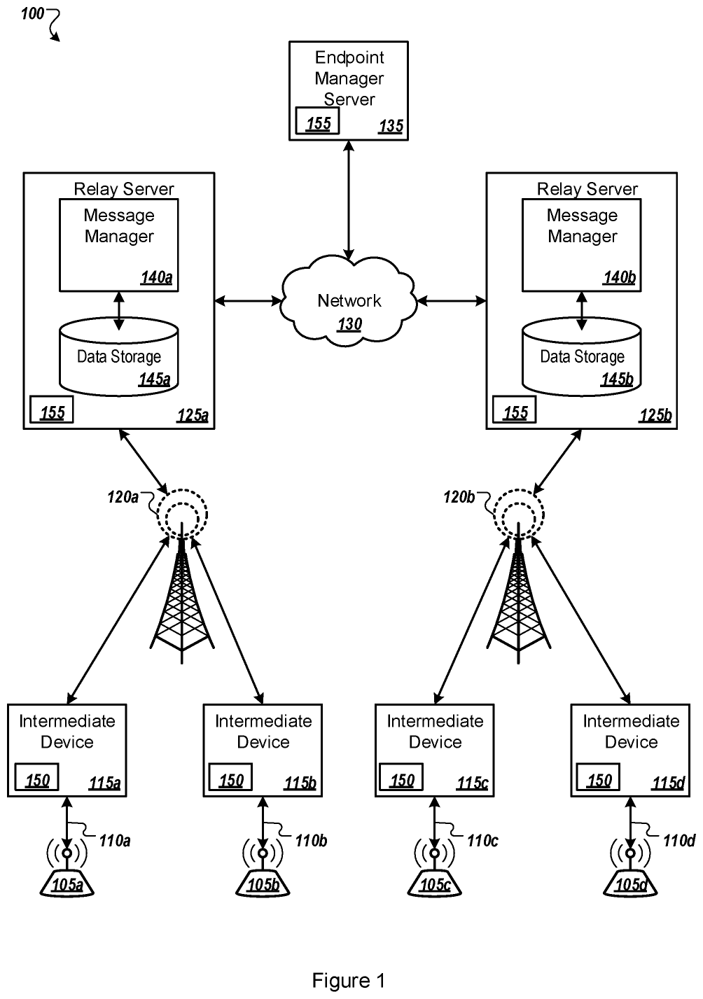

FIG. 1 illustrates an example network architecture 100 in which embodiments of the present disclosure may be implemented. The network architecture 100 may include one or more endpoint devices 105, one or more intermediate devices 115, one or more relay servers 125, and one or more endpoint manager servers 135. In some embodiments, the network architecture 100 may be capable to move data between one or more endpoint devices 105 and various endpoint manager servers 135 by way of crowd-sourced intermediate devices 115, which may function as network clients, and one or more relay servers 125.

An endpoint device 105 may include one or more IoT devices. The endpoint device 105 may include a power supply, a data collection device (e.g., a sensor), and a network device. The power supply may include a battery or a connection to a power grid. Additionally or alternatively, the power supply may include an energy harvesting apparatus, such as a solar panel, solar cell, solar photovoltaic, electromagnetic, etc. In at least some embodiments, the endpoint device 105 may not include a power supply and may instead use ambient backscatter techniques. The endpoint device 105 may also include one or more sensors. The one or more sensors may be configured to detect any type of condition, and generate electronic data based on a detected condition. For example, the endpoint device 105 may include a smart watch with a heart rate monitor that is configured to generate heart rate data using heart rate conditions collected by the heart rate monitor. In some embodiments, the endpoint device 105 does not have capability to communicate over the Internet and only includes hardware and/or software capable of communicating with nearby devices, such as a nearby intermediate device 115. In other embodiments, the endpoint device 105 may include hardware and/or software communicate over the Internet.

The network device of the endpoint device 105 may include any hardware, software, or combination thereof that is capable to communicate with another device via a network. In at least one embodiment, the network device may include any network controller configured to communicate via a short-range network, such as Bluetooth® or any other short-range network. In at least one embodiment, the network device may include any network controller configured to communicate via a low-power network. Example endpoint devices 105 include, but are not limited to, industrial devices, residential appliances, commercial equipment, inventory trackers, smart watches, wearables, heart rate monitors, logistics trackers, environmental sensors, cash registers, credit card readers, point-of-sale (POS), bikes, electric scooters, electric skate boards, cars, electric cars, satellites, or any device (mobile and not mobile that includes a wireless radio interface. The network architecture 100 may include any number of endpoint devices 105 and the endpoint devices 105 in the network architecture 100 may be any type of endpoint device 105, including any type of network-capable device. The endpoint devices 105 may be fixed or relatively stationary in the network architecture 100, such as a POS or a pollution sensor. Additionally or alternatively, the endpoint devices 105 may be mobile, such as a smart watch, or any car or vehicle.

The one or more endpoint devices 105 may be configured to communicate with other devices via at least one wireless network 110. For example, a first endpoint device 105a may be in electronic communication with a first intermediate device 115a via a wireless network 110a. The one or more intermediate devices 115 may include any type of device capable of communicating with an endpoint device 105 via the wireless network 110 and with a relay server 125 via a second network 120. In at least one embodiment, an intermediate device 115 may include two network controllers—a first network controller to communicate via the wireless network 110 and a second network controller to communicate via the second network 120. Example intermediate devices 115 include mobile devices, personal computers (PC), laptops, smart phones, netbooks, e-readers, personal digital assistants (PDA), cellular phones, mobile phones, tablets, vehicles, drones, cars, trucks, wearable devices, routers, televisions, or set top boxes, etc.

As illustrated, the first endpoint device 105a may be in electronic communication with the first intermediate device 115a via the wireless network 110a (e.g., a short-range network). Further, a second endpoint device 105b may be in electronic communication with a second intermediate device 115b via another wireless network 110b (e.g., a low-power network). A third endpoint device 105c may be in electronic communication with a third intermediate device 115c via another wireless network 110c. A fourth endpoint device 105d may be in electronic communication with a fourth intermediate device 115d via another wireless network 110d.

In some embodiments, the wireless network 110 may be any network that uses a relatively low amount of power. Example wireless networks 110 may include any Bluetooth® network type (e.g., Bluetooth Low Energy (BLE), Bluetooth 4.0, Bluetooth 5.0, Bluetooth Long Range), NB-IoT, LTE Direct, LTE-M, LTE M2M, 5G, Wi-Fi, Wi-Fi Aware or any low-power network. The one or more endpoint devices 105 may connect to various intermediate devices 115 using different types of wireless networks 110. For example, the first endpoint device 105a may be in electronic communication with the first intermediate device 115a via a first short-range wireless network 110a and the second endpoint device 105b may be in electronic communication with the second intermediate device 115b via a second short-range wireless network 110b.

Endpoint devices 105, intermediate devices 115, or both, may be fixed, relatively stationary or moveable. When an endpoint device 105 and an intermediate device 115 come into wireless range of each other, the endpoint device 105 and the intermediate device 115 may perform a handshake and/or authentication to initiate data exchange between the endpoint device 105 and the intermediate device 115.

In some embodiments, the endpoint device 105 may periodically send beacons that include data via the wireless network 110. The endpoint devices 105 may include various services that may run on the endpoint devices 105. For example, a smart watch may include a clock service, a heart rate monitor service, a motion detection service, a music service, etc. Beacons may be generated for each of these services or a single beacon may be generated to include data for some or all of the services.

An intermediate device 115 may listen for such beacons from endpoint devices. Responsive to receiving a beacon, the intermediate device 115 may send the beacon to a relay server 125 via a second network 120. In at least one embodiment, the wireless network 110 and the second network 120 are different types of networks. For example, the wireless network 110 may be a Bluetooth® network and the second network 120 may be a cellular network, Wi-Fi, or the Internet.

The second network 120 may include a public network (e.g., the Internet), a private network (e.g., a local area network (LAN) or wide area network (WAN)), a wired network (e.g., Ethernet network), a wireless network (e.g., an 802.xx network or a Wi-Fi network), a cellular network (e.g., a Long Term Evolution (LTE) or LTE-Advanced network, 1G, 2G, 3G, 4G, 5G, etc.), routers, hubs, switches, server computers, and/or a combination thereof.

The relay server 125 may send the beacon, or information related to the beacon, to an endpoint manager server 135 via a third network 130. The third network 130 may include a public network (e.g., the Internet), a private network (e.g., a local area network (LAN) or wide area network (WAN)), a wired network (e.g., Ethernet network), a wireless network (e.g., an 802.xx network or a Wi-Fi network), a cellular network (e.g., a Long Term Evolution (LTE) or LTE-Advanced network, 1G, 2G, 3G, 4G, 5G, etc.), routers, hubs, switches, server computers, and/or a combination thereof. In at least one embodiment, the second network 120 and the third network 130 are the same network or include at least some overlapping components.

The one or more relay servers 125 may include one or more computing devices, such as a rackmount server, a router computer, a server computer, a personal computer, a mainframe computer, a laptop computer, a tablet computer, a desktop computer, smartphone, cars, drones, a robot, any mobility device that has an operating system, etc.), data stores (e.g., hard disks, memories, databases), networks, software components, and/or hardware components. The one or more relay servers 125 may be configured to receive a beacon from an intermediate device 115. The one or more relay servers 125 may send the beacon, or data related to or associated with to an endpoint manager server 135. The one or more relay servers 125 may receive a message from the endpoint manager server 135 and, in some embodiments, may send the message from the endpoint manager server 135 to an intermediate device 115. In at least some embodiments, the intermediate device 115 may perform one or more operations responsive to receiving the message from the endpoint manager server 135. The operations include operations local to the intermediate device 115, and/or sending the message from the endpoint manager server 135 to an endpoint device 105.

The endpoint manager server 135 may include one or more computing devices, such as a rackmount server, a router computer, a server computer, a personal computer, a mainframe computer, a laptop computer, a tablet computer, a desktop computer, a smartphone, a car, a drone, a robot, any mobility device that has an operating system etc.), data stores (e.g., hard disks, memories, databases), networks, software components, and/or hardware components. The endpoint manager server 135 may be associated with one or more endpoint devices 105. For example, a particular corporation, person, or manufacturer may sell an endpoint device 105 and may use an endpoint manager server 135 to communicate with and/or control the endpoint device 105.

The endpoint manager server 135 may send messages associated with a particular endpoint device 105, or a set of endpoint devices 105. For example, the endpoint manager server 135 may send updates (e.g., firmware, software) to the particular endpoint device 105, or the set of endpoint devices 105. The endpoint manager server 135 may send other communications to an endpoint device 105, such as a response to a request from a beacon generated by the particular endpoint device 105.

Each relay server 125 may include a message manager 140. The message manager 140 may be implemented using hardware including a processor, a microprocessor (e.g., to perform or control performance of one or more operations), an FPGA, or an ASIC. In some other instances, the message manager 140 may be implemented using a combination of hardware and software. Implementation in software may include rapid activation and deactivation of one or more transistors or transistor elements such as may be included in the hardware of a computing system (e.g., the relay server 135). Additionally, software defined instructions may operate on information within transistor elements. Implementation of software instructions may at least temporarily reconfigure electronic pathways and transform computing hardware.

Each relay server 125 may include a data storage 145. The data storage 145 may include any memory or data storage. In some embodiments, the data storage 145 may include computer-readable storage media for carrying or having computer-executable instructions or data structures stored thereon. The computer-readable storage media may include any available media that may be accessed by a general-purpose or special-purpose computer, such as a processor. For example, the data storage 145 may include computer-readable storage media that may be tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may be included in the data storage 145. In the depicted embodiment, the data storage 145 is part of the relay server 125. In some embodiments, the data storage 145 may be separate from the relay server 125 and may access the data storage 145 via a network. In at least one embodiment, the data storage 145 may include multiple data storages.

The data storage 145 may include data pertaining to the endpoint devices 105, intermediate devices 115, and endpoint manager servers 135 and relationships between the endpoint devices 105, intermediate devices 115, and endpoint manager servers 135. For example, the data storage 145 may include a table or list of endpoint devices that are associated with a particular endpoint manager server 135. The data storage 145 may include data pertaining to beacons received from endpoint devices, such as a timestamp of the receipt of the beacon, a timestamp associated with the creation of the beacon, a geo-location associated with the beacon and/or the endpoint device 105 that created or transmitted the beacon, sensor data associated with the endpoint device, routing information for how and/or where to send data between endpoint manager servers 135 and endpoint devices 105, connection strengths between intermediate devices and endpoint devices, proximity of an endpoint device 105 to an intermediate device 115, type of wireless network 110 that connects an intermediate device 115 and an endpoint device 105, a cost of a connection between an intermediate device 115 and an endpoint device 105, a current battery level of the intermediate device, a type of intermediate device, etc.

The message manager 140 may process communications between the endpoint devices 105, the intermediate devices 115 and the endpoint manager server(s) 135. In an example, the message manager 140 may receive a beacon from the intermediate device 115a via the second network 120a. The beacon may have been sent to the intermediate device via the wireless network 110a by endpoint device 105a. A beacon may contain characteristics about the endpoint device 105, including an identifier of the endpoint device 105 (e.g., a MAC address, a unique ID), a geographical location of the endpoint device 105a, and advertisements of the UUIDs of the services it supports, etc. The message manager 140 may identify the characteristics of the beacon, such as by analyzing the beacon to identify information pertaining to the beacon. The message manager 140 may access the data storage 145 to identify, based on the characteristics of the beacon, an endpoint manager server 135 that is associated with the beacon. For example, the identifier of the endpoint device may be associated with a particular manufacturer that operations a particular endpoint manager server 135. The message manager 140 may identify this particular endpoint manager server 135 in the data storage 145 and an address and/or path to send the beacon in order to reach the endpoint manager server 135. In at least some embodiments, the message manager 140 may send the beacon, or a beacon message to the endpoint manager server 135 via the third network 130. The beacon message may include the beacon, may not include the beacon, or may include information pertaining to the beacon.

In at least one embodiment, a beacon may include data from multiple services associated with the endpoint device 105. Additionally or alternatively, multiple beacons from a single endpoint device 105 may be generated and broadcast via the wireless network 110. Each of these multiple beacons, for example, may be associated with a different service associated with the endpoint device 105. The message manager 140 may identify the services, and based on information for the service, identify an appropriate endpoint manager server 135 that should receive a beacon message.

The endpoint manager server 135 may receive the message from the relay server 125. The endpoint manager server 135 may store the message, process the message, generate a report based on the message, may generate a notification or response based on the message, or any other action. For example, endpoint manager server 135 may generate a response message pertaining to the beacon message. The response message may include a message intended for one or more of the relay server 125, an intermediate device 115, the endpoint device 105 that generated the beacon, or another endpoint device 105 that did not generate the beacon. The endpoint manager server 135 may send the response message to the same relay server 125 that sent the beacon message to the endpoint manager server 135 (e.g., the relay server 125a), or to a different relay server 125 that did not send the beacon message to the endpoint manager server 135 (e.g., relay server 125b).

The relay server 125 may receive, from the endpoint manager server 135, the response message pertaining to the beacon message. The relay server 125 may process the response message, such as by performing operations at the relay server 125, sending data to another device (e.g., a user device), sending data to an endpoint device 105, etc.

The network architecture 100 may be used to exchange data between any devices capable of network-based communication in a manner that is different than conventional communication over the Internet.

In an example, the network architecture 100 may leverage existing smartphone infrastructure to create delay-tolerant connectivity. The network architecture 100 can move data to the cloud in an initially delay tolerant fashion, which may be useful for many types of IoT communications such as firmware updates, status updates, log-file storage, and micropayments. The intermediate device may include software that runs on smartphones to periodically scan for other devices (e.g., the endpoint devices 105) like industrial devices, smartwatches, wearables, logistics trackers, and environmental sensors. These endpoint devices 105 may connect with the software client running on the smartphones to create massive, area wide networks for moving data to and within the cloud.

Further, it has been estimated that 95% of the human population is covered by some sort of cellular service. The network architecture 100 can be deployed anywhere in the world and enables regions of lower connectivity to increase their connectivity. Moreover, the network architecture 100 can provide coverage beyond the reach of conventional cellular networks by using software that runs on Bluetooth®-enabled smartphones, for example. Users may travel to areas of limited or no cellular connectivity, but still may receive beacons from endpoint devices 105 via the wireless network 110. Using the network architecture 100, telco operators, for example, can now easily deploy a software update to their user devices to begin communicating with endpoint devices 105 as described herein to provide higher latency IoT connectivity to even the remotest regions of the world.

In a specific example, the network architecture 100 can be used for asset tracking and management. For example, the network architecture 100 can be used to find lost items that are configured as an endpoint device 105, such as a skateboard with a wireless radio chipset, an attached tracking beacon, a laptop, etc. A user, for example, may indicate that the item is lost, such as by using a mobile application or website to indicate, to the endpoint manager server 135 or to the relay server 125, that the item is lost. In a first embodiment, the endpoint manager server 135 may send a message to one or more relay servers 125 to watch for the lost item. The relay servers 125 may add an identifier of the lost item to a lost item watch list. As intermediate devices 115 move to different geographic locations, they can receive beacons from different endpoint devices 103. The intermediate devices 115 then forward the beacons to the relay servers 125. When a relay server 125 server receivers a beacon, the relay server 125 can analyze the beacon to determine if the beacon originated at an endpoint device 105 that is on the watch list. When the relay server 125 identifies a beacon that originated at an endpoint device 105 that is on the watch list, the relay server 125 can notify the endpoint manager server 135 that the lost item has been found. In at least some embodiments, the relay server 125 may send the notification that the lost item has been found as a push notification or as a pull notification (i.e., in response to a request from the endpoint manager server 135). In at least some embodiments, the relay server 125 may send the notification that the lost item has been found to the user device that was used by the user to indicate that the item was lost.

As the intermediate devices 115 and/or the endpoint devices 105 move to different geographic locations, the manner they communicate in the network architecture 100 may change. For example, if one of the endpoint devices 105 moves to a location where it is no longer close enough to one of the intermediate devices 115 to be able to communicate with it, then it may continue to send beacons even though there is no device within range to receive the beacons. Furthermore, the endpoint devices 105 may continue to send beacons until one of the intermediate devices 115 is within range. Similarly, the intermediate devices 115 may move to locations out of a range of the endpoint devices 105, and the network architecture 100 may adapt accordingly.

The network architecture 100 may select one of the intermediate devices 115 to communicate and/or forward beacons for a corresponding one of the endpoint devices 105. For example, one of the relay servers 125 may select one of the intermediate devices 115 to handle sending the response message to one of the endpoint devices 105. The relay server 125 may use any selection criteria to select which intermediate device 115 to use to send the response message, such as a connection strength between the intermediate device 115 and the target endpoint device 105, a proximity of an endpoint device 105 to an intermediate device 115, a type of wireless network 110 that connects an intermediate device 115 and an endpoint device 105, a cost of a connection between an intermediate device 115 and an endpoint device 105, a current battery level of the intermediate device, a type of intermediate device, etc.

In some circumstances, two of the intermediate devices 115b may be within range of one of the endpoint devices 105 and both may receive the same beacon from the endpoint device 105. Further, both of the intermediate devices 115 may forward the beacon of the endpoint device 105 to one of the relay servers 125. To reduce redundancy, network traffic, battery impact, etc., the relay server 125 may select one of the intermediate devices 115 and the intermediate devices 115 to handle communication with the endpoint device 105 and instruct the non-selected intermediate device to ignore beacons from the endpoint device 105, to discard beacons from the endpoint device 105, to stop sending beacons from the endpoint device 105, or any other operation that may reduce network congestion, free-up data storage space, free-up processor capabilities, etc.

As more intermediate devices 115 become available for data transport, data transmission frequency for a particular intermediate device 115 may decrease. In the long term, with enhanced density intermediate device 115 and machine learning based protocols, the technology described here may significantly improve battery life for intermediate devices 115, reduce network congestion, improve global connectivity, etc. The relay server 125 may use any selection criteria to select which intermediate device 105 to use to communicate with the endpoint device 105 and which intermediate device 115 to cease communications regarding the endpoint device 105, such as a connection strength between the intermediate device 115 and the target endpoint device 105, a proximity of the endpoint device 105 to the intermediate device 115, a type of wireless network 110 that connects the intermediate device 115 and the endpoint device 105, a cost of a connection between the intermediate device 115 and the endpoint device 105, a current battery level of the intermediate device 115, a type of intermediate device 115, etc.

It may be desirable for network operators to uniquely identify some of the devices in the network architecture 100, such as the endpoint devices 105. One way for the endpoint devices 105 to be identified is by its MAC Address, which may be defined by the hardware of the endpoint devices 105 (for example, the Bluetooth chipset). However, using the MAC address for identification may be associated with several significant disadvantages.

First, identifying the endpoint devices 105 by its MAC Address means that this same address cannot be randomized in order to avoid the endpoint devices 105 from being tracked by third parties, which may result in security and privacy concerns. For example, the owner of the endpoint device 105 may be tracked simply by checking where the endpoint device 105 is located (e.g., via GPS or network connection location). This may be a significant concern for wearable devices such as watches, which are intended to be worn by its owner at all times, and may allow its owner to be tracked at all times. Second, the MAC Address of a device may be easily spoofed by another device with the right hardware and software. Thus, MAC Addresses are not a good way to identify devices because of security and privacy concerns.

Accordingly, any of the devices of FIG. 1 (e.g., the endpoint devices 105, intermediate devices 115, relay servers 125, endpoint manager server 135, etc.) may be identified using an identifier other than a MAC Address. In particular, the present disclosure includes identifiers that are difficult to spoof and appear random to third parties while linkable to the network's devices for the network's operator only. Additionally, the disclosed identifiers are relatively easy to implement and fast to compute (without requiring too many operations), which makes them suitable to implement in devices that rely on small batteries and relatively low performance and low power hardware.

In at least one embodiment, the endpoint devices 105 and/or the intermediate devices 115 may include a device ID generator 150. The device ID generator 150 may be implemented using hardware including a processor, a microprocessor (e.g., to perform or control performance of one or more operations), an FPGA, or an ASIC. In some other instances, the device ID generator 150 may be implemented using a combination of hardware and software. Implementation in software may include rapid activation and deactivation of one or more transistors or transistor elements such as may be included in the hardware of a computing system (e.g., the endpoint devices 105 and/or the intermediate devices 115). Additionally, software defined instructions may operate on information within transistor elements. Implementation of software instructions may at least temporarily reconfigure electronic pathways and transform computing hardware.

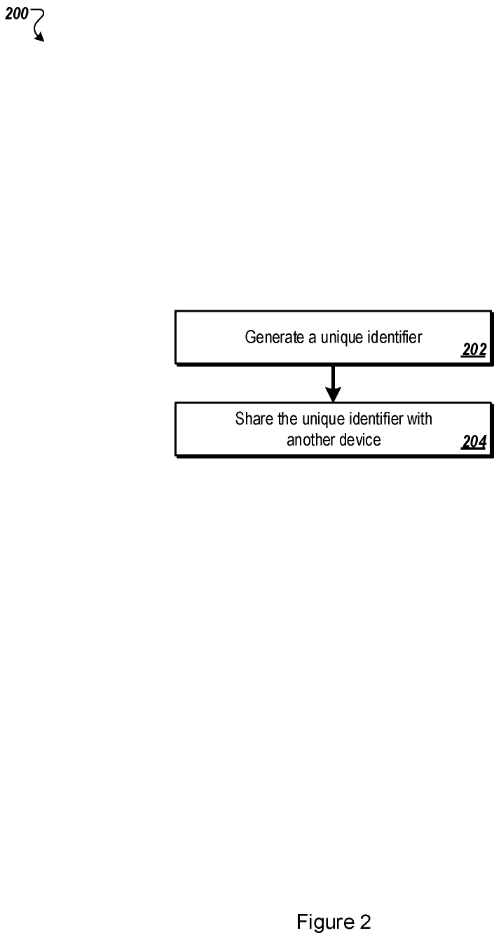

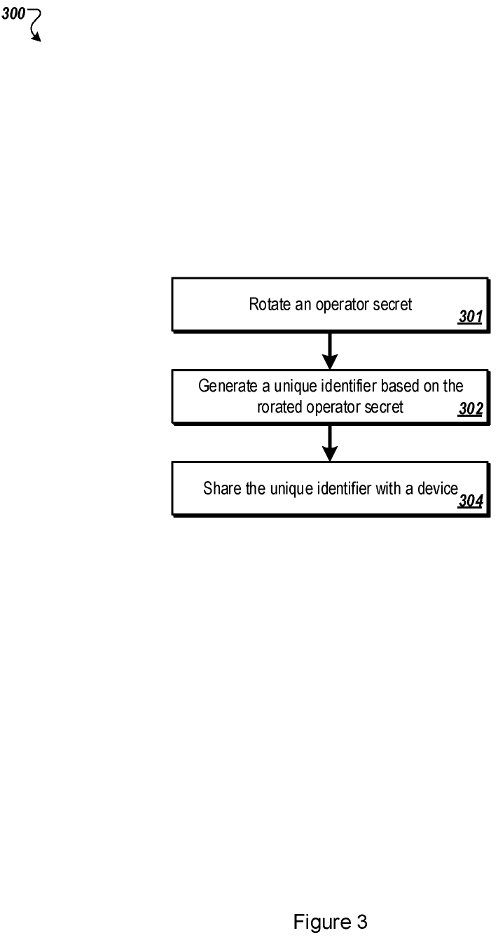

The device ID generator 150 may generate a unique identifier for the device on which it resides that is not understandable by third parties but that may be easily linked to the device by a network operator, by the relay server 125, and/or the endpoint manager server 135. The device ID generator 150 may generate a unique identifier may generate the unique identifier using method described in FIGS. 2 and 3.

In at least one embodiment, the relay server(s) 125 and/or the endpoint manager server 135 may include a device ID decoder 155. The device ID decoder 155 may be implemented using hardware including a processor, a microprocessor (e.g., to perform or control performance of one or more operations), an FPGA, or an ASIC. In some other instances, the device ID decoder 155 may be implemented using a combination of hardware and software. Implementation in software may include rapid activation and deactivation of one or more transistors or transistor elements such as may be included in the hardware of a computing system (e.g., the relay server(s) 125 and/or the endpoint manager server 135). Additionally, software defined instructions may operate on information within transistor elements. Implementation of software instructions may at least temporarily reconfigure electronic pathways and transform computing hardware.

The device ID decoder 155 may decode a unique identifier that is received from the endpoint devices 105 and/or the intermediate devices 115. The unique identifier may correspond to at least one of the endpoint devices 105 and/or the intermediate devices 115.

The device ID generator 150 and the device ID decoder 155 may communicate with each other in an effort to securely and privately identify networked devices. For example, the device ID generator 150 and the device ID decoder 155 may communicate an operator secret with each other. In at least one embodiment, the operator secret is defined at the device ID decoder 155 and sent to each of the endpoint devices 105 and/or the intermediate devices 115. In turn, the device ID generator 150 at the endpoint devices 105 and/or the intermediate devices 115 may use the operator secret to generate the unique identifier, which may include a hashed value based on both a device's MAC address and the operator secret. Additional details are further described in conjunction with FIGS. 2 and 3.

Modifications, additions, or omissions may be made to the network architecture 100 without departing from the scope of the present disclosure. The present disclosure more generally applies to the network architecture 100 including one or more endpoint devices 105, one or more wireless networks, one or more intermediate devices 115, one or more second networks 120, one or more relay servers 125, one or more third networks 130, and one or more endpoint manager servers 135 or any combination thereof.

Moreover, the separation of various components in the embodiments described herein is not meant to indicate that the separation occurs in all embodiments. In addition, it may be understood with the benefit of this disclosure that the described components may be integrated together in a single component or separated into multiple components.

FIGS. 2-3 illustrate flow diagrams of example methods to securely and privately identify networked devices. The methods described may be used to thwart malicious third parties from recognizing beacons that devices emit. The method may be implemented to protect the security and privacy of devices, and the users associated with such devices.

The methods may be performed by processing logic that may include hardware (circuitry, dedicated logic, etc.), software (such as is run on a general purpose computer system or a dedicated machine), or a combination of both, which processing logic may be included in the endpoint devices 105, intermediate device 115 and/or the relay server 125 of FIG. 1, or another computer system or device. However, another system, or combination of systems, may be used to perform the methods.

For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 2 illustrates a flow diagram of an example method 200 methods to securely and privately identify networked devices. For example, the example method 200 may be performed by at least one of the endpoint devices 105 of FIG. 1 to securely and privately identify networked devices. The method 200 may begin at block 202, wherein a unique identifier may be generated. In some embodiments, the unique identifier may be generated at a device, such as one of the endpoint devices 105.

In some aspects, the unique identifier may be a Unique Static ID (USID) specific to each device, designed to identify the device with a limited number of semi-trusted parties (such as a network operator and/or IoT connectivity provider). In such configurations, it may be desirable to generate a unique identifier that is not understandable by third parties but that may be easily linked to the device by the network operator.

In some embodiments, the unique identifier may be generated based on the following algorithm: id=hash(operatorSecret, deviceMacAddress). In the algorithm, “id” may be the device's identifier, or the USID, which may be shared with third parties. “Hash” may be a hashing algorithm, for example, a Secure Hash Algorithm (SHA) or other suitable hashing algorithm. “OperatorSecret” may be a secret known by the network or device operator. “DeviceMacAddress” may be the MAC Address of the device's hardware. In some configurations, the device may use a randomized MAC Address when sending packets to the public or other devices. In such configurations, the device may still use the device's hardware MAC Address for generation of the unique identifier to identify itself with the network operator.

In such configurations, the semi-trusted parties only see the unique identifier (e.g., the USID) but they are not able to get the operator's secret (e.g., OperatorSecret) or even get the device's MAC Address (e.g., DeviceMacAddress). However, the network operator knows the operator's secret (e.g., OperatorSecret) it defined and the MAC Address of its devices (e.g., DeviceMacAddress). For example, the network operator may obtain the MAC Address of its devices from the manufacturer of the devices. Based on this information, the network operator may recompute the unique identifier (e.g., the USID) of each of its devices and retrieve their associated data on the third parties' tools.

Accordingly, the unique identifier is a hashed value based on both a device's MAC address (which may be defined by hardware rather than being assigned randomly) and the operator secret. Since the unique identifier may include a hashed value based on both a device's MAC address and the operator secret, the unique identifier appears random to third parties while being identifiable to the network's operator. In addition, the USID may be shared with semi-trusted third parties, thereby making the device identifiable to the semi-trusted third parties without revealing the MAC Address of the device or the operator's secret. Furthermore, the unique identifier is difficult to spoof because others do not know the operator's secret and therefore others would not be able to generate the USID (whether or not others know the MAC Address of the device). Additionally, the hash value for the unique identifier is easy and quick to compute, even by IoT devices that rely on small batteries and have relatively low performance and low power hardware.

At block 204, the unique identifier may be shared with another device. For example, the unique identifier may be shared with a limited number of semi-trusted parties (such as a network operator and/or IoT connectivity provider). The unique identifier may be transmitted to another device, for example, owned by the network operator, device operator, or a semi-trusted third party. The unique identifier (e.g., USID) may be transmitted as part of a beacon from a device, for example, wirelessly via Bluetooth or other suitable connection.

As mentioned above, the method 200 may be used to identify the device with a limited number of semi-trusted parties. However, in some circumstances it may be desirable to identify the device with an unlimited number of parties, at least some of which may be untrusted parties. In at least one embodiment, the unique identifier (e.g., USID) may be regenerated and shared periodically which may further thwart malicious users who somehow gain access to the unique identifier (e.g., USID).

FIG. 3 illustrates a flow diagram of an example method 300 methods to securely and privately identify networked devices. In some aspects, the method 300 may be used to identify the device with an unlimited number of untrusted parties. The method 300 may be implemented when the unique identifier (e.g., USID) is to be advertised or broadcast publicly. For example, the unique identifier may be broadcast publicly by being embedded inside a Bluetooth Beacon for geolocation purposes or other applications or configurations.

Similar to the method 200, the method 300 may include block 302, in which a unique identifier may be generated, and block 304, in which the unique identifier may be shared with another device. However, the method 300 may also include block 301, in which the operator secret is rotated. In some configurations, the operator secret may be rotated before or at the time the unique identifier is generated.

In some aspects, the operator secret may be rotated based on a rotation algorithm. The rotation algorithm may be predefined and may be known only to the device and/or the network operator. Furthermore, the rotation algorithm may rotate the operator secret based on predefined parameters, and the predefined parameters may be known only to the device and/or the network operator. In addition, in some circumstances the rotation algorithm and/or the predefined parameters may be known to trusted third parties (in addition to the network operator). The rotation algorithm may be used to rotate or change the operator secret used in generating the unique identifier, such as id=hash(operatorSecret, deviceMacAddress). The rotation algorithm and/or the predefined parameters may be used to decode the unique identifier such that the network operator and/or trusted third parties may be able to identify the device.

In such configurations, the unique identifier (e.g., USID) appears random to outside observers and third parties and yet still may be used to identify the device by the device's operators, network operators, and/or owners. While the unique identifier in method 200 may typically stay the same, the unique identifier in method 300 changes based on the rotating operator secret. Thus, it appears random to third parties. Furthermore, the third parties are not able to get the operator's secret (e.g., OperatorSecret) or the device's MAC Address (e.g., DeviceMacAddress).

However, the network operator knows the operator's secret (e.g., OperatorSecret) it defined and the MAC Address of its devices (e.g., DeviceMacAddress). The network operator also knows the rotation algorithm and its parameters, and may therefore recompute the rotating operator's secret. Based on this information, the network operator may recompute the unique identifier (e.g., the USID) of each of its devices and retrieve their associated data on the third parties' tools.

Accordingly, the unique identifier in method 300 may include a hashed value based on both a device's MAC address (which may be defined by hardware rather than being assigned randomly) and a rotating operator secret. Since the unique identifier is a hashed value based on both a device's MAC address and the rotating operator secret, the unique identifier appears random to third parties while being identifiable to the network's operator. In at least one embodiment, the unique identifier may include a hashed value that may be generated based on two or more of a device's MAC address, the operator secret, and the predefined parameters. The operator secret may rotate. Additionally or alternatively, the predefined parameters may change, which may also change the unique identifier. Furthermore, the unique identifier is difficult to spoof because others do not know the rotating algorithm or parameters used to rotate the operator's secret and therefore others would not be able to generate the USID (whether or not others know the MAC Address of the device).

As mentioned above, some devices may be identified by their MAC addresses. In some circumstances, the MAC address may be defined by hardware associated with the device (e.g., such as the Bluetooth hardware). However, in other circumstances the MAC address may be randomized. For example, the MAC address of a device may be randomly assigned and reassigned, so it cannot be used to identify the device. This may be done to preserve security and privacy for the device. Nevertheless, in some circumstances, users or subscribers of an IoT network may want its devices to be identifiable, and therefore have a non-randomized identifier. For example, the non-randomized identifier could be used to know which of its devices collected which data. Accordingly, the unique identifiers described herein could be used to identify devices while maintaining privacy and security. The unique identifiers (e.g., USID's) described are unique and static but yet do not expose private data to the members of the network.

These unique identifiers may be generated by hashing the MAC address of the edge node with the customer's developer key and replacing the Runtime Identifiers (RIDs) when starting a desired software development kit. In some circumstances, this configuration may be an opt-in only system for specialized use cases. If a network subscriber enables these kinds of unique identifiers when configuring the software development kit will be able to filter the data it collected by this device specific unique identifiers (e.g., USID), since the network only sees the hashed unique identifiers it is not possible for any member of the network to retrieve the MAC address used to generate the unique identifiers, however the network subscriber can use a list of its own MAC addresses and its developer key to regenerate the unique identifiers used by its edge nodes and thus know precisely which IoT devices were detected by its edge nodes.

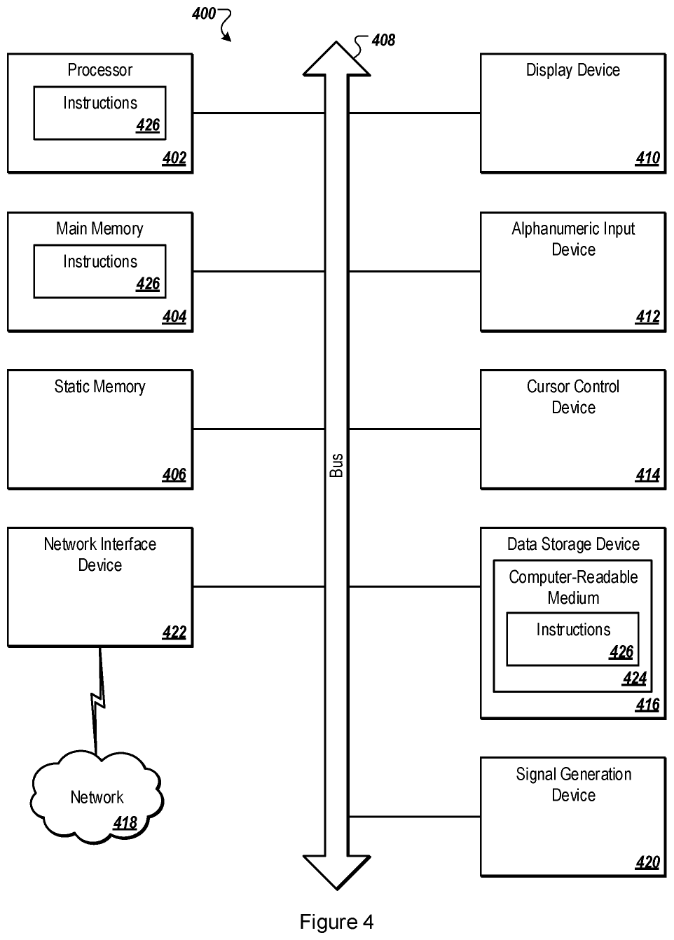

FIG. 4 illustrates a diagrammatic representation of a machine in the example form of a computing device 700 within which a set of instructions, for causing the machine to perform any one or more of the methods discussed herein, may be executed. The computing device 700 may include a mobile phone, a smart phone, a netbook computer, a rackmount server, a router computer, a server computer, a personal computer, a mainframe computer, a laptop computer, a tablet computer, a desktop computer etc., within which a set of instructions, for causing the machine to perform any one or more of the methods discussed herein, may be executed. In alternative embodiments, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The example computing device 700 includes a processing device (e.g., a processor) 702, a main memory 704 (e.g., read-only memory (ROM), flash memory, dynamic random access memory (DRAM) such as synchronous DRAM (SDRAM)), a static memory 706 (e.g., flash memory, static random access memory (SRAM)) and a data storage device 716, which communicate with each other via a bus 708.

Processing device 702 represents one or more general-purpose processing devices such as a microprocessor, central processing unit, or the like. More particularly, the processing device 702 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 702 may also include one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein.

The computing device 700 may further include a network interface device 722 which may communicate with a network 718. The computing device 700 also may include a display device 710 (e.g., a liquid crystal display (LCD) or a cathode ray tube (CRT)), an alphanumeric input device 712 (e.g., a keyboard), a cursor control device 714 (e.g., a mouse) and a signal generation device 720 (e.g., a speaker). In at least one embodiment, the display device 710, the alphanumeric input device 712, and the cursor control device 714 may be combined into a single component or device (e.g., an LCD touch screen).

The data storage device 716 may include a computer-readable storage medium 724 on which is stored one or more sets of instructions 726 embodying any one or more of the methods or functions described herein. The instructions 726 may also reside, completely or at least partially, within the main memory 704 and/or within the processing device 702 during execution thereof by the computing device 700, the main memory 704 and the processing device 702 also constituting computer-readable media. The instructions may further be transmitted or received over a network 718 via the network interface device 722.

While the computer-readable storage medium 726 is shown in an example embodiment to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

In one example, a method may include generating a unique identifier for an endpoint device. The unique identifier may be specific to the endpoint device and may be configured to identify the endpoint device with at least one semi-trusted party. The unique identifier may be a hashed value based on both the endpoint device's MAC address and an operator secret known to a network operator. The method may include sharing the unique identifier with another device.

In some aspects, the MAC address may be defined by hardware of the endpoint device. The unique identifier may be shared wirelessly. The unique identifier may be shared via a network operated by a network operator.

The unique identifier may be generated according to algorithm id=hash(operatorSecret, deviceMacAddress), wherein id is the unique identifier, hash is a hashing algorithm, operatorSecret is a secret known by a network operator, and deviceMacAddress is a MAC Address define by hardware of the endpoint device. The hashing algorithm may be a Secure Hash Algorithm (SHA).

The unique identifier may not be understandable by third parties and may be linkable to the endpoint device by a network operator. The unique identifier may be generated at the endpoint device. The method may include recomputing the unique identifier at a network operator. Sharing the unique identifier with another device may include transmitting the unique identifier to another device owned by a network operator.

The method may include rotating the operator secret. The operator secret may be rotated based on a rotation algorithm known to a network operator. The rotation algorithm may include predefined parameters known to the network operator.

In another example, a method may include rotating an operator secret known to a network operator, generating a unique identifier for an endpoint device, and sharing the unique identifier with another device. The unique identifier may be specific to the endpoint device and may be configured to identify the endpoint device. The unique identifier may be based on the operator secret and an identifier of the endpoint device.

The identifier of the endpoint device may be a MAC address. The MAC address may be defined by hardware of the endpoint device. The operator secret may be known to the network operator. The unique identifier may be shared wirelessly via a network operated by the network operator.

The unique identifier may be generated according to algorithm id=hash(operatorSecret, deviceMacAddress), wherein id is the unique identifier, hash is a hashing algorithm, operatorSecret is the secret known by the network operator, and deviceMacAddress is a MAC Address define by hardware of the endpoint device. The hashing algorithm may be a Secure Hash Algorithm (SHA).

Terms used herein and especially in the appended claims (e.g., bodies of the appended claims) are generally intended as “open” terms (e.g., the term “including” may be interpreted as “including, but not limited to,” the term “having” may be interpreted as “having at least,” the term “includes” may be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases may not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” may be interpreted to mean “at least one” or “one or more”); the same holds true for the use of definite articles used to introduce claim recitations.

In addition, even if a specific number of an introduced claim recitation is explicitly recited, those skilled in the art will recognize that such recitation may be interpreted to mean at least the recited number (e.g., the bare recitation of “two recitations,” without other modifiers, means at least two recitations, or two or more recitations). Further, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, may be understood to contemplate the possibilities of including one of the terms, either of the terms, or both terms. For example, the phrase “A or B” may be understood to include the possibilities of “A” or “B” or “A and B.”

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data which cause a general purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

For the processes and/or methods disclosed, the functions performed in the processes and methods may be implemented in differing order as may be indicated by context. Furthermore, the outlined steps and operations are only provided as examples, and some of the steps and operations may be optional, combined into fewer steps and operations, or expanded into additional steps and operations.

This disclosure may sometimes illustrate different components contained within, or connected with, different other components. Such depicted architectures are merely exemplary, and many other architectures can be implemented which achieve the same or similar functionality.

Aspects of the present disclosure may be embodied in other forms without departing from its spirit or essential characteristics. The described aspects are to be considered in all respects illustrative and not restrictive. The claimed subject matter is indicated by the appended claims rather than by the foregoing description. All changes which come within the meaning and range of equivalency of the claims are to be embraced within their scope.

What is claimed is:

1. A method, comprising:
generating a unique identifier for an endpoint device, wherein the unique identifier is specific to the endpoint device and is configured to identify the endpoint device with at least one semi-trusted party; and
sharing the unique identifier with another device.

2. The method of claim 1, wherein the unique identifier is a hashed value based on both the endpoint device's MAC address and an operator secret known to a network operator.

3. The method of claim 2, wherein the MAC address is defined by hardware of the endpoint device.

4. The method of claim 1, wherein the unique identifier is shared wirelessly.

5. The method of claim 1, wherein the unique identifier is shared via a network operated by a network operator.

6. The method of claim 1, wherein the unique identifier is generated according to an algorithm: id=hash(operatorSecret, deviceMacAddress), wherein id is the unique identifier, hash is a hashing algorithm, operatorSecret is a secret known by a network operator, and deviceMacAddress is a MAC Address define by hardware of the endpoint device.

7. The method of claim 6, wherein the hashing algorithm is a Secure Hash Algorithm (SHA).

8. The method of claim 1, wherein the unique identifier is not understandable by third parties and is linkable to the endpoint device by a network operator.

9. The method of claim 1, wherein the unique identifier is generated at the endpoint device, further comprising recomputing the unique identifier at a network operator.

10. The method of claim 1, wherein sharing the unique identifier with another device comprises transmitting the unique identifier to another device owned by a network operator.

11. The method of claim 2, further comprising rotating the operator secret.

12. The method of claim 11, wherein the operator secret is rotated based on a rotation algorithm known to a network operator.

13. The method of claim 12, wherein the rotation algorithm includes predefined parameters known to the network operator.

14. A method, comprising:
rotating an operator secret known to a network operator;
generating a unique identifier for an endpoint device, wherein the unique identifier is specific to the endpoint device and is configured to identify the endpoint device, the unique identifier based on the operator secret and an identifier of the endpoint device; and
sharing the unique identifier with another device.

15. The method of claim 14, wherein the identifier of the endpoint device is a MAC address.

16. The method of claim 15, wherein the MAC address is defined by hardware of the endpoint device.

17. The method of claim 14, wherein the operator secret is known to the network operator.

18. The method of claim 14, wherein the unique identifier is shared wirelessly via a network operated by the network operator.

19. The method of claim 14, wherein the unique identifier is generated according to an algorithm id=hash(operatorSecret, deviceMacAddress), wherein id is the unique identifier, hash is a hashing algorithm, operatorSecret is the secret known by the network operator, and deviceMacAddress is a MAC Address define by hardware of the endpoint device.

20. The method of claim 19, wherein the hashing algorithm is a Secure Hash Algorithm (SHA).
